(19) United States
(12) Patent Application Publication
(10) Pub. No.: US 2021/0319166 A1
(43) Pub. Date: Oct. 14, 2021

(54) EDITABLE MULTICELL MULTICATEGORY DOCUMENT PRESENTATION

(71) Applicant: Microsoft Technology Licensing, LLC, Redmond, WA (US)

(72) Inventors: Peng LYU, Sammamish, WA (US); Kai-Uwe MAETZEL, Seattle, WA (US)

(21) Appl. No.: 16/846,231

(22) Filed: Apr. 10, 2020

(51) Int. Cl. G06F 40/103; G06F 21/53

(52) U.S. Cl. CPC G06F 40/103; G06F 9/45558; G06F 21/53

(57) ABSTRACT

Tools and techniques enhance presentation and editing of notebook documents and other multicell multicategory documents. Some embodiments improve presentation performance by distinguishing non-viewable cells and then not connecting an editor to a particular cell until that cell is viewable. Some improve security by separating cell content rendering based on the category of content in each cell. Notebook cell content such as markdown language code or scripts can be rendered in a sandbox for added security. Some embodiments allow shared scope and other communication between cells that contain respective executable contents, instead of placing each rendered cell in its own isolated context. Some permit the order in which executable cells are presented visually to differ from the order in which those cells are executed. Integrated development environments may be enhanced to have editors for notebook documents, including notebook editors that have the same first-class status as source code editors.

### BACKGROUND

With the ongoing development of computer software, many different kinds of digital documents have become available for use in various ways. Plain text prose, formatted text prose, formatted or plain text computer source code, and markup/markdown language text are each widely used, and each can be edited using various software tools. Images are also presented to human viewers in various digital documents, and in some cases the images can also be edited by the viewer. Text and images may be combined in a single document, by using a suitable word processor, or computer-aided design software, or graphics editing software, for example.

“Notebook documents” (sometimes called “notebooks”) are recent additions to this landscape of documents. A notebook may include both prose text and computer code, e.g., a script written in a script programming language. Executing the script of a notebook may produce a graph or other image that is also part of the notebook. Editing the script will result in a corresponding update to the image generated by the script. Some notebooks can be edited, executed, and presented in a web browser, by using a client-server software application designed for such notebooks.

Accordingly, advances in technology for presenting or editing notebook documents would be beneficial.

### SUMMARY

Some embodiments described in this document provide improved technology for presenting or editing notebook documents and other multicell multicategory documents. In particular, some embodiments improve presentation performance by avoiding connecting an editor or other content presentation functionality to a particular cell of the document until that cell is actually viewable. Some embodiments improve security in an efficient manner by separating cell content rendering for different cells, based on the category of content in each cell. Some embodiments enhance cells' computational capabilities by allowing communication between cells that contain respective executable content, instead of placing each rendered cell in its own isolated context. Some embodiments enhance presentation flexibility and execution flexibility by permitting the order in which executable cells are presented visually to differ from the order in which those cells are executed.

Some embodiments use or provide a hardware and software combination which includes a digital memory and a processor which is in operable communication with the memory. The processor is configured, e.g., by tailored software, to perform certain steps for presenting content of a multicell multicategory document to an editor user interface. These steps include (a) identifying a viewable cell of the multicell multicategory document which is distinct from at least one non-viewable cell of the multicell multicategory document, (b) determining a category of content of the viewable cell, (c) connecting the viewable cell to a content presentation functionality for content of the determined category, and (d) avoiding connecting the non-viewable cell to any content presentation functionality while the non-viewable cell is not viewable.

Some embodiments use or provide a method for presenting content of a multicell multicategory document. This includes automatically identifying a viewable cell of the multicell multicategory document which is distinct from at least one non-viewable cell of the multicell multicategory document, determining a category of content of the viewable cell, connecting the viewable cell to an editor which has content presentation functionality for content of the determined category, rendering the viewable cell for presentation to a user, and avoiding rendering the non-viewable cell while it is not viewable. These embodiments aid computational performance by avoiding rendering non-viewable cell content for presentation.

Some embodiments use or provide a computer-readable storage medium configured with data and instructions which upon execution by a processor cause a computing system to perform a method for presenting content of a multicell multicategory document. This includes opening the multicell multicategory document, identifying a viewable cell of the multicell multicategory document which is distinct from at least one non-viewable cell of the multicell multicategory document, determining a category of content of the viewable cell, connecting the viewable cell to an editor which has content presentation functionality for content of the determined category, rendering the viewable cell for presentation to a user, thereby displaying document content, and avoiding rendering the non-viewable cell while it is not viewable. Some of these embodiments open the document and display document content in the editor without first rendering more than one-tenth of the document, for example, resulting in a corresponding performance improvement over approaches that render non-viewable content.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating computer systems generally and also illustrating configured storage media generally;

FIG. 2 is a block diagram illustrating a computing system equipped with multicell multicategory document viewing functionality, and some aspects of a surrounding context;

FIG. 3 is a block diagram illustrating an enhanced system configured with multicell multicategory document viewing and editing functionality;

FIG. 4 is a block diagram illustrating some examples of multicell multicategory document content;

FIG. 5 is a block diagram illustrating some aspects of multicell multicategory documents or enhanced functionality systems;

FIG. 6 is a diagram illustrating rendering multicell multicategory document cells in separate layers and compositing the render results for presentation to a user;

FIG. 7 is a flowchart illustrating steps in some multicell multicategory document presentation methods; and

FIG. 8 is a flowchart further illustrating steps in some multicell multicategory document presentation methods.

### DETAILED DESCRIPTION

### Overview

Innovations may expand beyond their origins, but understanding an innovation's origins can help one more fully appreciate the innovation. In the present case, some teachings described herein were motivated by technical challenges faced by Microsoft innovators who were working to improve the usability of Microsoft's software development offerings, and in particular to enhance the functionality of integrated development environments such as the Microsoft Visual Studio® and VSCode™ tools (marks of Microsoft Corporation).

In particular, a technical challenge was to how to open large notebooks in an editor within an acceptable short time. In this context, a notebook editor is an interactive computational environment for creating and manipulating notebook documents. The notebook documents used by the innovators as examples are JSON documents that contain an ordered list of input/output cells which can contain source code, structured text (e.g., markdown), plots, and rich media.

To help address this computational performance challenge, in some of the embodiments taught herein the rendering of notebook documents opened in an enhanced editor is virtualized, so only a visible part of the notebook document is rendered. Rich media like HTML and JavaScript®-based interactive graphs are rendered separately from source code and structured text, to help ensure a performant rendering (mark of Oracle America, Inc.). Some versions of the enhanced notebook editor can also support multiple languages in a single notebook document and provide rich language services based on the language each code input cell is using, by making the notebook editor an equal-class entity within the integrated development environment, e.g., an entity that is equal in terms of status, interfaces, and authorizations to other editors such as source code editors.

Other technical challenges are also addressed by teachings herein. For example, with the benefit of hindsight it became apparent to the innovators that cybersecurity could be enhanced without unduly sacrificing performance, by selective use of a sandbox for rendering cell content such as HTML and scripts, without using the sandbox (and attendant overhead) to render the editor user interface or static output. It also became apparent in hindsight that inter-cell communication limitations that have been imposed by some other approaches to notebook editing could be avoided, by rendering cells into layers instead of into individual scopes, and then compositing the layers for visual presentation.

Other aspects of these embodiments, and other notebook presentation and editing enhancement embodiments, are also described herein.

Operating Environments

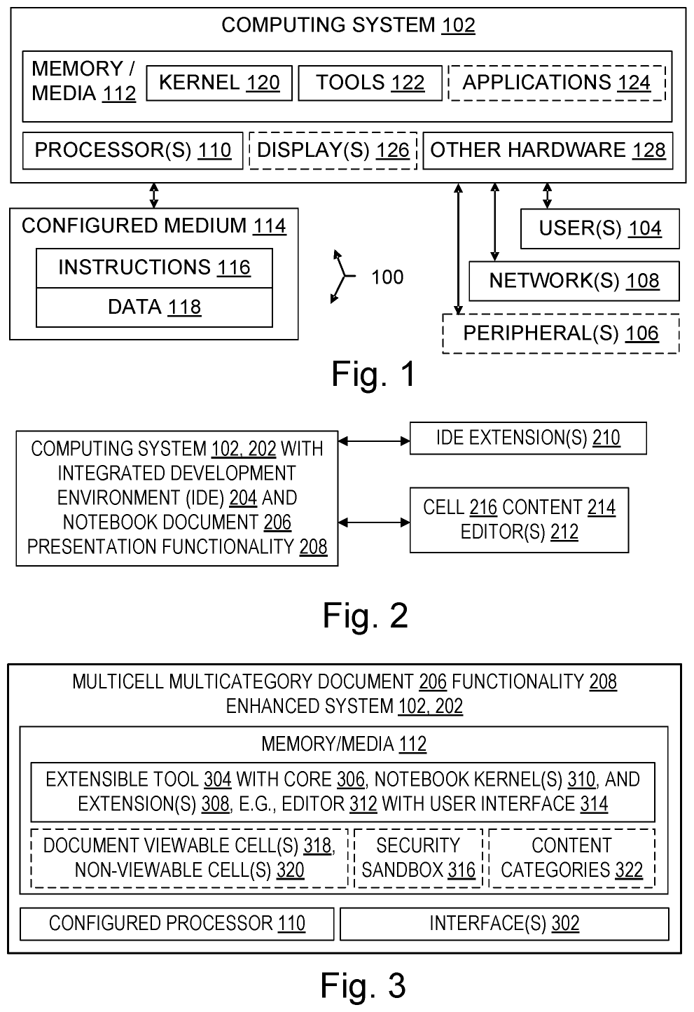

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of user 104. Automated agents, scripts, playback software, devices, and the like acting on behalf of one or more people may also be users 104, e.g., to facilitate testing a system 102. Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a network 108 via network interface equipment, for example.

Each computer system 102 includes at least one processor 110. The computer system 102, like other suitable systems, also includes one or more computer-readable storage media 112. Storage media 112 may be of different physical types. The storage media 112 may be volatile memory, non-volatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable non-volatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage medium 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs and/or GPUs), memory/storage media 112, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments peripherals 106 such as human user I/O devices (screen, keyboard, mouse, tablet, microphone, speaker, motion sensor, etc.) will be present in operable communication with one or more processors 110 and memory.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud or enterprise network. In particular, notebook editing and presentation functionality could be installed on an air gapped network and then be updated periodically or on occasion using removable media. A given embodiment may also communicate technical data and/or technical instructions through direct memory access, removable nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

More about Systems

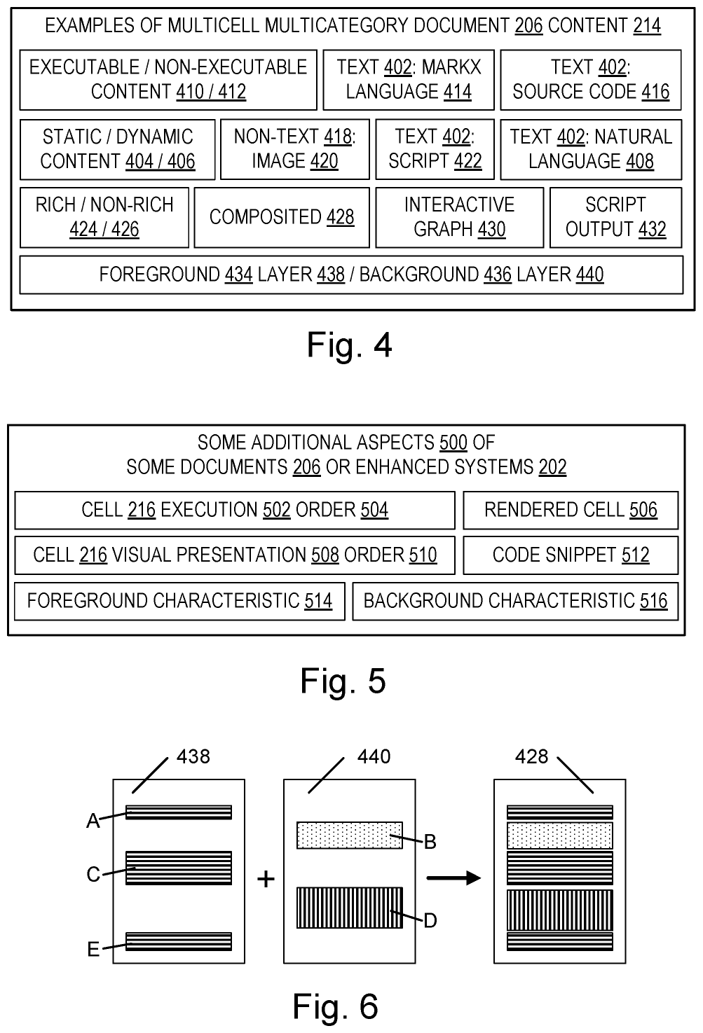

FIG. 2 illustrates an environment having an enhanced system 202, 102 that includes an integrated development environment (IDE) 204, zero or more notebook documents 206, and notebook presentation functionality 208. Notebooks and other multicell multicategory documents 206 include cells 216 which contain respective contents 214 that may belong to different content categories 322; some examples are shown in FIG. 4. The surrounding context in this example includes one or more IDE extensions 210 and one or more editors 212 for editing content 214 of the notebook document.

FIG. 3 illustrates an enhanced system 202 which is configured with functionality 208 for performing presentation and editing of notebooks and other multicell multicategory documents 206. The system 202 may be networked generally or may communicate in particular (via network or otherwise) with document 206 repositories or other document 206 storage 112 through one or more APIs or other interfaces 302.

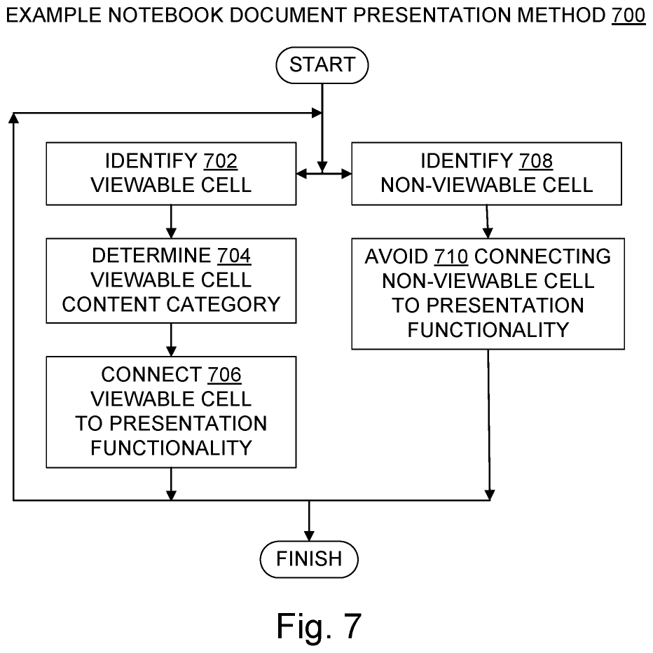

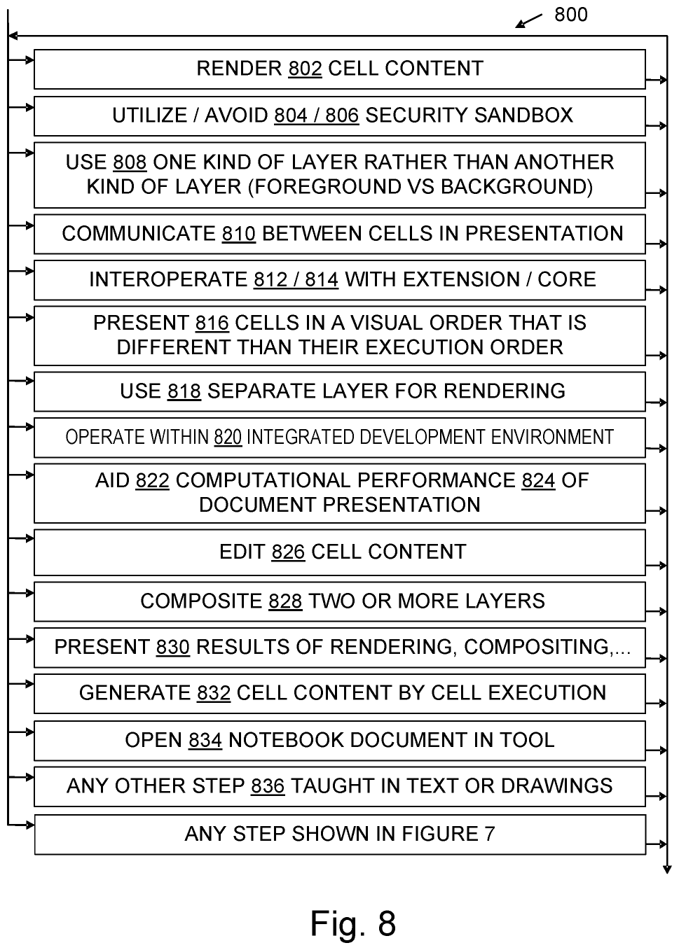

The illustrated system 202 includes an extensible software development tool 304 or another industrial, academic, or information processing tool 304 that is configured to perform computations that retrieve, present, edit, copy, parse, execute, or otherwise process data 118 and instructions 116 of document 206 content 214. For example, an enhanced system 202 may perform a method 800 illustrated in FIG. 8 or FIG. 7 or both. In particular, the tool 304 may be, or may include, an IDE 204 enhanced with notebook functionality 208 as taught herein.

In the FIG. 3 example, the tool 304 is extensible in that it has a core 306 which is designed to interoperate with extensions 308. Extensions 308 may include, e.g., source code editors, programming language-specific servers (e.g., for linting, refactorization, autocompletion during editing). A notebook editor 312 with a user interface 314 that displays notebooks 206 is provided, with the same or similar core 306 interoperability as other editor extensions. The core itself or some of the extensions, or both, may include a notebook kernel 310 which can interpret or otherwise execute program scripts or other content 214 of notebook documents 206. The notebook kernel 310 may invoke or reside in an operating system kernel 120, or the notebook kernel 310 may reside partially or entirely within a tool extension 308.

In some configurations the enhanced system 202 includes a security sandbox 316, which may execute within an isolated virtual machine or isolated container for example. The sandbox may also utilize hypervisor isolation. The notebook functionality 208 in these configurations includes the sandbox 316, which is employed, e.g., to more safely execute scripts or other executable content 214 of a notebook document 206.

When the notebook functionality 208 is in use, the enhanced system 202 includes a notebook or other multicell multicategory document 206. It is contemplated that in many situations, the notebook document cells 216 of a document 206 that is open in an editor 312 at a given point in time will include both viewable cells 318, 216 and non-viewable cells 320, 216. A viewable cell is a cell whose content is at least partially visible in a display 126 on the enhanced system 202, or at least will be displayed subject only to finishing rendering (that is, without any scrolling, window resizing, document opening or closing, or other user-initiated actions).

FIG. 4 illustrates several examples of multicell multicategory document content 214; each example shown may be treated as a content category 322, or examples may be bundled into a single shared category, e.g., text 402, 322. The examples are not necessarily mutually exclusive, e.g., text 402 may be static content 404 such as natural language prose 408. These items are discussed at various points herein, and additional details regarding them are provided in the discussion of a List of Reference Numerals later in this disclosure document.

FIG. 5 shows some additional aspects 500 of some documents 206 or some enhanced systems 202. These items are discussed at various points herein, and additional details regarding them are provided in the discussion of a List of Reference Numerals later in this disclosure document.

FIG. 6 shows a foreground layer 438 with three viewable cells labeled A, C, and E, and a background layer 440 with two three viewable cells labeled B and D. As illustrated, the two layers are composited to produce composited content 428 which is displayed to a user.

Some embodiments use or provide a functionality-enhanced system, such as system 202 or another system 102 that is enhanced as taught herein. In some embodiments, a system which is configured for presenting content of a multicell multicategory document includes a digital memory 112 and a processor 110 in operable communication with the memory. The processor 110 is configured to perform steps for presenting content 214 of a multicell multicategory document 206 to an editor user interface 314. The steps include (a) identifying a viewable cell 318 of the multicell multicategory document which is distinct from at least one non-viewable cell 320 of the multicell multicategory document, (b) determining a category 322 of content of the viewable cell, (c) connecting the viewable cell to a content presentation functionality 312 for content of the determined category, and (d) avoiding connecting the non-viewable cell to any content presentation functionality while the non-viewable cell is not viewable.

In some embodiments, the viewable cell 318 is one of a plurality of viewable cells, at least one of the plurality includes executable content 410 and at least another of the plurality includes non-executable content 412. The system 202 is configured to render the non-executable content in a foreground layer 438, to render the executable content in a background layer 440, and to present composited layer results 428 to the user.

Some embodiments include an integrated development environment 204 which includes the editor user interface 314.

Some embodiments include a security sandbox 316. The system 202 is configured to render executable content 410 of the viewable cell in the security sandbox.

In some embodiments, the system 202 is characterized by at least one of the following foreground characteristics 514 and is also characterized by at least one of the following background characteristics 516: a foreground characteristic under which compilable source code content 416 of the document is rendered in a foreground layer 438 rather than a background layer 440, a foreground characteristic under which natural language text content 408 of the document is rendered in a foreground layer 438 rather than a background layer 440, a foreground characteristic under which static content 404 of the document is rendered in a foreground layer 438 rather than a background layer 440, a background characteristic under which markup language content 414 of the document is rendered in a background layer 440 rather than a foreground layer 438, a background characteristic under which interpretable script content 422 of the document is rendered in a background layer 440 rather than a foreground layer 438, a background characteristic under which dynamic content 406 of the document is rendered in a background layer 440 rather than a foreground layer 438, or a background characteristic under which dynamic content 406 of the document is rendered in a background layer 440 which is isolated within a security sandbox 316.

In some embodiments, the multicell multicategory document 206 has at least two viewable cells 318 with respective executable content 410, and the executable contents communicate electronically with each other during execution 502 of the executable content.

Some embodiments, include an integrated development environment 204 which includes a core 306 that is configured to interoperate with extensions 308, and the content presentation functionality 208 interoperates with the integrated development environment core 306.

In some embodiments, the multicell multicategory document 206 includes multiple cells 216 with respective executable content 410, the cells are arranged in an execution order 504, and in operation the system 202 presents rendered cells in a visual presentation order 510 which differs from the execution order.

In some embodiments, the system 202 is configured to render dynamic media 406 separately from static media 404 in at least one of the following ways: by using a separate layer (438 or 440 or multiples of either or both) for each category 322 of media, or by using a sandbox 316 for only the dynamic media.

In some embodiments, the system 202 is configured to render the editor user interface 314 in a foreground layer 438.

Other system embodiments are also described herein, either directly or derivable as system versions of described processes or configured media, duly informed by the extensive discussion herein of computing hardware.

Although specific architectural examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different technical features, mechanisms, sequences, data structures, or functionalities for instance, and may otherwise depart from the examples provided herein.

Processes (a.k.a. Methods)

FIG. 7 illustrates a family of methods 700 that may be performed or assisted by an enhanced system, such as system 202 or another functionality 208 enhanced system as taught herein. FIG. 8 further illustrates notebook presentation and editing methods (which may also be referred to as “processes” in the legal sense of that word) that are suitable for use during operation of a system which has innovative functionality taught herein. FIG. 8 includes some refinements, supplements, or contextual actions for steps shown in FIG. 7. FIG. 8 also incorporates steps shown in FIG. 7.

Technical processes shown in the Figures or otherwise disclosed will be performed automatically, e.g., by an enhanced system 202 or software component thereof, unless otherwise indicated. Processes may also be performed in part automatically and in part manually to the extent action by a human administrator or other human person is implicated, e.g., in some embodiments a human user may specify a visual presentation order 510 by rearranging cells 216 through a drag-and-drop procedure using a mouse. No process contemplated as innovative herein is entirely manual.

In a given embodiment zero or more illustrated steps of a process may be repeated, perhaps with different parameters or data to operate on. Steps in an embodiment may also be done in a different order than the top-to-bottom order that is laid out in FIGS. 7 and 8. Steps may be performed serially, in a partially overlapping manner, or fully in parallel. In particular, the order in which flowchart 700 action items or flowchart 800 action items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

In some embodiments, cells 216 are tightly integrated with each other, e.g., through binding, shared execution scope, passage of execution control, signaling, procedure calls, and other program execution mechanisms. These mechanisms are referred to generally herein as “communication” between cells.

Some embodiments use or provide a method for presenting 830 content of a multicell multicategory document 206, including the following automatic steps: identifying 702 a viewable cell of the multicell multicategory document which is distinct from at least one non-viewable cell of the multicell multicategory document, determining 704 a category of content of the viewable cell, connecting 706 the viewable cell to an editor which has content presentation functionality for content of the determined category, rendering 802 the viewable cell for presentation to a user, and avoiding 710 connecting or rendering the non-viewable cell while it is not viewable. This method aids 822 performance 824 by avoiding rendering non-viewable cell content for presentation.

Some embodiments distinguish between a foreground 434 and a background 436, giving each one or more layers for rendering different categories of cell content, and then present the combined results to the user. In some embodiments, the viewable cell 318 noted above is one of a plurality of viewable cells, at least one of the plurality includes executable content 410 and at least another of the plurality includes non-executable content 412. In this embodiment, the method includes rendering 802 the non-executable content in a foreground layer 438, rendering the executable content in a background layer 440, compositing 828 results of the renderings, and presenting 830 the composited results 428 to a user.

In some embodiments, the cells' execution order 504 may be different than their visual presentation order 510. For example, the visual presentation order of the example illustrated in FIG. 6 is A, B, C, D, E. But it may occur, for instance, that cell D includes script content that generates 832 content displayed in cells A and E, and that cell B includes script content that generates 832 content displayed in cell C after the content of cell A is generated, because execution of cell B uses a result of execution of cell D. Then the execution order would be D, B (if only executable cells are considered) or D, A-and-E, B, C (if executable cells and cells with their generated content are considered). More generally, in some embodiments the multicell multicategory document 206 includes multiple cells with respective executable content, the cells are arranged in an execution order 504, and the method presents rendered cells in a visual presentation order 510 which differs from the execution order.

In some embodiments, the multicell multicategory document includes executable content 410 in at least one cell and includes non-executable content 412 in at least one other cell, and the method executes the executable content in a sandbox 316 in security isolation from the non-executable content.

Some embodiments include notebook editing functionality 208 integrated in an IDE 204, such as a Visual Studio® or VSCode™ IDE (marks of Microsoft Corporation) or another IDE. In particular, some methods include editing 826 the content of the viewable cell by using the editor within an integrated development environment. In some, the multicell multicategory document includes multiple cells containing respective source code snippets 512, and the method renders 802 the source code snippets by using the editor within an integrated development environment.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as notebook documents 206, extensible tools 304, notebook kernels 310, editors 312, viewable cells 318, non-viewable cells 320, security sandboxes 316, cell content categories 322, and rendering layers 438, 440, in the form of data 118 and instructions 116, read from a removable storage medium 114 and/or another source such as a network connection, to form a configured storage medium. The configured storage medium 112 is capable of causing a computer system 102 to perform technical process steps for notebook document presentation 830 and editing 826, as disclosed herein. The Figures thus help illustrate configured storage media embodiments and process (a.k.a. method) embodiments, as well as system and process embodiments. In particular, any of the process steps illustrated in FIG. 7 or 8, or otherwise taught herein, may be used to help configure a storage medium to form a configured storage medium embodiment.

Some embodiments use or provide a computer-readable storage medium 112, 114 configured with data 118 and instructions 116 which upon execution by at least one processor 110 cause a computing system to perform a method for presenting content of a multicell multicategory document. This method includes: opening 834 the multicell multicategory document, identifying 702 a viewable cell of the multicell multicategory document which is distinct from at least one non-viewable cell of the multicell multicategory document, determining 704 a category of content of the viewable cell, connecting 706 the viewable cell to an editor which has content presentation functionality for content of the determined category, rendering 802 the viewable cell for presentation to a user, thereby displaying document content, and avoiding connecting 710 or rendering the non-viewable cell while it is not viewable. This method is further characterized in that the method opens the document and displays document content in the editor without first rendering more than one-tenth of the document.

In some embodiments, rendering 802 the viewable cell for presentation to the user is performed as part of rendering a viewable portion of the document, and rendering the viewable portion includes rendering textual content in a foreground layer and rendering rich content in a background layer. In some cases, the textual content 402 includes at least one of: natural language text, or source code which is not configured for execution within the document editor. In some, the rich content 424 includes at least one of: hypertext markup language, script code which is configured for execution within the document editor, or an interactive graph.

In some embodiments, the method renders 802 rich content of a first viewable cell in a sandbox, and the method renders non-rich content of a second viewable cell outside the sandbox for presentation to the user in a textual editor in an integrated development environment.

In some embodiments, the method includes utilizing 818 multiple background layers for rendering respective cells of the document, and also utilizing 808 at least one foreground layer for rendering at least one other cell of the document.

### Additional Examples and Observations

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, some additional examples and observations are offered.

Additional support for the discussion above is provided below. For convenience, this additional support material appears under various headings. Nonetheless, it is all intended to be understood as an integrated and integral part of the present disclosure's discussion of the contemplated embodiments.

Technical Character

The technical character of embodiments described herein will be apparent to one of ordinary skill in the art, and will also be apparent in several ways to a wide range of attentive readers. Some embodiments address technical activities such as opening 834, presenting 830, or editing 826 digital notebook documents 206, executing 502 scripts 422, rendering 802 digital document 206 cells 216, and interoperating 812, 814 with tool extensions 308 and tool cores 306, each of which is an activity deeply rooted in computing technology. Some of the technical mechanisms discussed include, e.g., tool extensions 308, foreground layers 438, background layers 440, security sandboxes 316, user interfaces 314, and executable cell content 410. Some of the technical effects discussed include, e.g., faster presentation 830 performance, inter-cell communication 810 capability, improved security, and integration within an IDE. Thus, purely mental processes are clearly excluded. Other advantages based on the technical characteristics of the teachings will also be apparent to one of skill from the description provided.

Some embodiments described herein may be viewed by some people in a broader context. For instance, concepts such as change, dependency, safety, speed, or visibility may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to reduce a from-open-request-to-editable time duration for notebook documents. Other configured storage media, systems, and processes involving change, dependency, safety, speed, or visibility are outside the present scope. Accordingly, vagueness, mere abstractness, lack of technical character, and accompanying proof problems are also avoided under a proper understanding of the present disclosure.

Additional Combinations and Variations

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular motivating examples and scenarios, operating system environments, feature examples, software processes, development tools, identifiers, data structures, data formats, notations, control flows, naming conventions, or other implementation choices described herein. Any apparent conflict with any other patent disclosure, even from the owner of the present innovations, has no role in interpreting the claims presented in this patent disclosure.

Acronyms, Abbreviations, Names, and Symbols

Some acronyms, abbreviations, names, and symbols are defined below. Others are defined elsewhere herein, or do not require definition here in order to be understood by one of skill.

ALU: arithmetic and logic unit

API: application program interface

BIOS: basic input/output system

CD: compact disc

CPU: central processing unit

CSV: comma-separated values

DVD: digital versatile disk or digital video disc

FPGA: field-programmable gate array

FPU: floating point processing unit

GPU: graphical processing unit

GUI: graphical user interface

HTML: hypertext markup language

IaaS or IAAS: infrastructure-as-a-service

ID: identification or identity

IoT: Internet of Things

IP: internet protocol

JSON: JavaScript® Object Notation (mark of Oracle America, Inc.)

LAN: local area network

OS: operating system

PaaS or PAAS: platform-as-a-service

RAM: random access memory

ROM: read only memory

TCP: transmission control protocol

TPU: tensor processing unit

UDP: user datagram protocol

UEFI: Unified Extensible Firmware Interface

URI: uniform resource identifier

URL: uniform resource locator

WAN: wide area network

Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

As used herein, a “computer system” (a.k.a. “computing system”) may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both.

“Cloud” means pooled resources for computing, storage, and networking which are elastically available for measured on-demand service. A cloud may be private, public, community, or a hybrid, and cloud services may be offered in the form of infrastructure as a service (laaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write).

“IoT” or “Internet of Things” means any networked collection of addressable embedded computing or data generation or actuator nodes. Such nodes may be examples of computer systems as defined herein, and may include or be referred to as a “smart” device, “endpoint”, “chip”, “label”, or “tag”, for example, and IoT may be referred to as a “cyber-physical system”. IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage—RAM chips or ROM chips provide the only local memory; (e) no CD or DVD drive; (f) embedment in a household appliance or household fixture; (g) embedment in an implanted or wearable medical device; (h) embedment in a vehicle; (i) embedment in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP, Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

“Access” to a computational resource includes use of a permission or other capability to read, modify, write, execute, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment. Notebook document processing operations such as identifying 708 non-viewable cells, connecting 706 viewable cells to an editor, rendering 802 cell content, compositing 828 layers, and many other operations discussed herein, are understood to be inherently digital. A human mind cannot interface directly with a CPU or other processor, or with RAM or other digital storage, to read and write the necessary data to perform the notebook document presentation and editing steps taught herein. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general purpose processor which executes it, thereby transforming it from a general purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as communicating, compositing, connecting, determining, editing, generating, identifying, interoperating, opening, presenting, rendering, utilizing (and communicates, communicated, composites, composited, etc.) with regard to a destination or other subject may involve intervening action such as the foregoing or forwarding, copying, uploading, downloading, encoding, decoding, compressing, decompressing, encrypting, decrypting, authenticating, invoking, and so on by some other party, including any action recited in this document, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:

100 operating environment, also referred to as computing environment

102 computer system, also referred to as a “computational system” or “computing system”, and when in a network may be referred to as a “node”

104 users, e.g., an analyst or other user of an enhanced system 202

106 peripherals

108 network generally, including, e.g., clouds, local area networks (LANs), wide area networks (WANs), client-server networks, or networks which have at least one trust domain enforced by a domain controller, and other wired or wireless networks; these network categories may overlap, e.g., a LAN may have a domain controller and also operate as a client-server network

110 processor

112 computer-readable storage medium, e.g., RAM, hard disks

114 removable configured computer-readable storage medium

116 instructions executable with processor; may be on removable storage media or in other memory (volatile or non-volatile or both)

118 data

120 system kernel(s), e.g., operating system(s), BIOS, UEFI, device drivers

122 tools, e.g., anti-virus software, firewalls, packet sniffer software, intrusion detection systems, intrusion prevention systems, other cybersecurity tools, debuggers, profilers, compilers, interpreters, decompilers, assemblers, disassemblers, source code editors, autocompletion software, simulators, fuzzers, repository access tools, version control tools, optimizers, collaboration tools, other software development tools and tool suites (including, e.g., integrated development environments), hardware development tools and tool suites, diagnostics, browsers, and so on

124 applications, e.g., word processors, web browsers, spreadsheets, games, email tools, commands

126 display screens, also referred to as “displays”

128 computing hardware not otherwise associated with a reference number 106, 108, 110, 112, 114

202 enhanced computers, e.g., computers 102 enhanced with notebook functionality 208

204 integrated development environment (IDE)

206 notebook document or another multicell multicategory document; some notebook documents use Python® script and JSON (mark of Python Software Foundation), but multicell multicategory document are not limited to these implementation choices

208 notebook functionality, e.g., functionality which does at least one of the following: conforms with the FIG. 7 flowchart or the FIG. 8 flowchart, conforms with any claim presented herein, or otherwise provides capabilities first taught herein

210 IDE extension

212 editor embedded in an IDE or in an IDE extension or in another software development tool

214 notebook cell content

216 notebook cell

302 interface, e.g., API, network interface card, communication protocol, or other digital interoperation mechanism

304 extensible tool

306 core of extensible tool which supports extensions; not to be confused with a processor core per se, although a core 306 may run on one or more processor cores

308 extensions to extensible tool

310 notebook kernel, e.g., Python® interpreter

312 editor (software, not person)

314 editor user interface

316 security sandbox

318 viewable cell

320 non-viewable cell; cells are not either inherently viewable or inherently non-viewable but rather their status changes depending on what portion of a document is within a current viewing window—that window may change due to scrolling, editing, window overlay, window resizing, and so on

322 cell content category; some examples of a content category are: static text (e.g., natural language prose, may be editable but does not execute), executable markdown (e.g., HTML), executable script (e.g., python, line magic, cell magic), and script output (e.g., graphs)

402 text content, e.g., cell content that is at least in part textual, as indicated for example by use of Unicode, ASCII, or other textual encodings

404 static content, namely, content which does not change as a result of cell execution or on its own; e.g., most natural language text, embedded images in formats such as .jpg or .bmp (but not .gif)

406 dynamic content, namely, content which changes as a result of cell execution or on its own, e.g., graphs 430, video, sound, content generated interactively

408 natural language text, e.g., text in English, Spanish, Chinese, Japanese, French, German, etc.

410 executable content, e.g., scripts or other software code; includes executable markdown or executable script content

412 non-executable content

414 markx language content, e.g., HTML or other text in a markup language or a markdown language

416 source code, e.g., text in a interpretable or compilable computer programming language

418 non-text content, e.g., graphic content, video content, sound recording content

420 image content, e.g., bitmap or vector graphics

422 script content, e.g., code written in Python®, PERL®, or another scripting language (marks of Python Software Foundation, DoseLogix, LLC)

424 rich content, e.g., HTML and JavaScript®-based interactive graphs (mark of Oracle America, Inc.)

426 non-rich content

428 composited content

430 interactive graph content

432 content which is output by executing a script

434 foreground (in the computer graphics sense)

436 background (in the computer graphics sense)

438 foreground layer

440 background layer

500 aspect of a document or a system or both

502 execution by a system 102 using processor and memory

504 cells execution order

506 rendered cell

508 visual presentation of cell, e.g., configuring a display 126 per the cell's content

510 cells visual presentation order

512 code snippet; an example of source code 416

514 foreground characteristic; use of or preference for rendering in foreground

516 background characteristic; use of or preference for rendering in background

700 flowchart; 700 also refers to notebook document presentation methods illustrated by or consistent with the FIG. 7 flowchart

702 computationally identify a viewable cell, e.g., based on the user's current focus position within a document, the dimensions of the window into which the document cell(s) will be rendered for viewing, any magnification (zoom in or out) that is in effect, the dimensions of the cells, cell visual presentation order, and the dimension of any margins to be placed between displayed cells' contents

704 computationally determine cell content category, e.g., based on JSON data or other indicators in the data structure which implements the cell

706 computationally connect a viewable cell to presentation functionality, e.g., by passing a cell data structure pointer or other ID to a display routine of an editor user interface

708 computationally identify a non-viewable cell, e.g., based on identification 702 data indicating cell will be outside display window area

710 avoid performing step 706

800 flowchart; 800 also refers to notebook document presentation or editing methods illustrated by or consistent with the FIG. 8 flowchart (which incorporates the steps of FIG. 7)

802 render cell content, e.g., by sending textual codes or pixels to a user interface display subroutine, executing script content or other executable content with a kernel 310, and otherwise making content or its generated output ready for display

804 utilize a security sandbox to execute a cell's executable content

806 avoid utilizing a notebook-documents-specific security sandbox to execute a cell's executable content

808 use one kind of layer rather than another, e.g., by using the foreground layer for static content and using the background layer for executable content

810 communicate directly and in real-time or near real-time between cells, as opposed to one cell writing to a file on disk and then another cell reading from that file minutes or longer afterward

812 interoperate with an extension, e.g., call or be called by an extension through an API

814 interoperate with a core 306, e.g., call or be called by a core 306 through an API

816 present cells in a visual order that differs from their execution order

818 use a separate layer for rendering; e.g., use a foreground layer and a background layer for rendering content in different content categories, or use different background layers for rendering content in different content categories (e.g., HTML in one and scripts in another)

820 operate within an IDE

822 improve computational performance

824 computational performance, e.g., as measured in wall clock time, processor cycles, or resource usage

826 edit cell content, e.g., add, delete, or rearrange content within a cell, or edit the cells themselves by adding, deleting or rearranging cells

828 composite two or more layers, in the computer graphics sense

830 present content, e.g., make it ready for display; does not necessarily include editing the content

832 generate output by executing content 410

834 open a notebook document, e.g., by using a file system to bring at least part of the document in memory accessible to an editor

836 any step discussed in the present disclosure that has not been assigned some other reference numeral

### CONCLUSION

In short, the teachings herein provide a variety of notebook document handling functionalities 208 which operate in enhanced systems 202. Tools and techniques enhance presentation 830 and editing 826 of notebook documents 206 and other multicell multicategory documents 206. Some embodiments improve 822 presentation 830 performance 824 by distinguishing 702, 708 non-viewable cells 320 and then not 710 connecting 706 an editor 312 to a particular cell 216 until that cell is viewable 318. Some embodiments improve security by separating 808, 818 cell content 214 rendering 802 based on the category 322 of content 214 in each cell 216. Higher risk notebook cell content 214, 406, 424, 410 such as markdown language code 414 or scripts 422 can be rendered 802 in a sandbox 316 for added security. Some embodiments allow shared variable or routine scope and other communication 810 between cells 216 that contain respective executable contents 410, instead of placing each rendered cell in its own isolated context. Some embodiments permit the order 510 in which executable cells 410 are presented 816 visually to differ from the order 504 in which those cells are executed 502. Integrated development environments 204 may be enhanced to have editors 312 that are specifically designed for notebook documents 206, including notebook 206 editors 312 that have the same first-class status as source code 416 editors 312.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with FIGS. 7 and 8 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of runtimes or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A system configured for presenting content of a multicell multicategory document, the system comprising:
a digital memory;
a processor in operable communication with the memory, the processor configured to perform steps for presenting content of a multicell multicategory document to an editor user interface, the steps including (a) identifying a viewable cell of the multicell multicategory document which is distinct from at least one non-viewable cell of the multicell multicategory document, (b) determining a category of content of the viewable cell, (c) connecting the viewable cell to a content presentation functionality for content of the determined category, and (d) avoiding connecting the non-viewable cell to any content presentation functionality while the non-viewable cell is not viewable.

2. The system of claim 1, wherein the viewable cell is one of a plurality of viewable cells, at least one of the plurality includes executable content and at least another of the plurality includes non-executable content, and the system is configured to render the non-executable content in a foreground layer, to render the executable content in a background layer, and to present composited layer results to the user.

3. The system of claim 1, further comprising an integrated development environment which includes the editor user interface.

4. The system of claim 1, further comprising a security sandbox, and wherein the system is configured to render executable content of the viewable cell in the security sandbox.

5. The system of claim 1, wherein the system is characterized by at least one of the following foreground characteristics and is also characterized by at least one of the following background characteristics:
a foreground characteristic under which compilable source code content of the document is rendered in a foreground layer rather than a background layer;
a foreground characteristic under which natural language text content of the document is rendered in a foreground layer rather than a background layer;
a foreground characteristic under which static content of the document is rendered in a foreground layer rather than a background layer;
a background characteristic under which markup language content of the document is rendered in a background layer rather than a foreground layer;
a background characteristic under which interpretable script content of the document is rendered in a background layer rather than a foreground layer;
a background characteristic under which dynamic content of the document is rendered in a background layer rather than a foreground layer; or
a background characteristic under which dynamic content of the document is rendered in a background layer which is isolated within a security sandbox.

6. The system of claim 1, wherein the multicell multicategory document has at least two viewable cells with respective executable content, and the executable contents communicate electronically with each other during execution of the executable content.

7. The system of claim 5, further comprising an integrated development environment which includes a core configured to interoperate with extensions, and wherein the content presentation functionality interoperates with the integrated development environment core.

8. The system of claim 1, wherein the multicell multicategory document includes multiple cells with respective executable content, the cells arranged in an execution order, and wherein the system in operation presents rendered cells in a visual presentation order which differs from the execution order.

9. The system of claim 1, wherein the system is configured to render dynamic media separately from static media in at least one of the following ways:
by using a separate layer for each category of media; or
by using a sandbox for only the dynamic media.

10. The system of claim 1, wherein the system is configured to render the editor user interface in a foreground layer.

11. A method for presenting content of a multicell multicategory document, the method comprising:
identifying a viewable cell of the multicell multicategory document which is distinct from at least one non-viewable cell of the multicell multicategory document;
determining a category of content of the viewable cell;
connecting the viewable cell to an editor which has content presentation functionality for content of the determined category;
rendering the viewable cell for presentation to a user; and
avoiding rendering the non-viewable cell while it is not viewable;
whereby the method aids performance by avoiding rendering non-viewable cell content for presentation.

12. The method of claim 11, wherein the viewable cell is one of a plurality of viewable cells, at least one of the plurality includes executable content and at least another of the plurality includes non-executable content, and the method comprises rendering the non-executable content in a foreground layer, rendering the executable content in a background layer, compositing results of the renderings, and presenting the composited results to a user.

13. The method of claim 11, wherein the multicell multicategory document includes multiple cells with respective executable content, the cells are arranged in an execution order, and the method presents rendered cells in a visual presentation order which differs from the execution order.

14. The method of claim 11, wherein the multicell multicategory document includes executable content in at least one cell and includes non-executable content in at least one other cell, and the method comprises executing the executable content in a sandbox in security isolation from the non-executable content.

15. The method of claim 11, further comprising editing the content of the viewable cell by using the editor within an integrated development environment.

16. The method of claim 11, wherein the multicell multicategory document includes multiple cells containing respective source code snippets, and the method renders the source code snippets by using the editor within an integrated development environment.

17. A computer-readable storage medium configured with data and instructions which upon execution by a processor cause a computing system to perform a method for presenting content of a multicell multicategory document, the method comprising:
opening the multicell multicategory document;
identifying a viewable cell of the multicell multicategory document which is distinct from at least one non-viewable cell of the multicell multicategory document;
determining a category of content of the viewable cell;
connecting the viewable cell to an editor which has content presentation functionality for content of the determined category;
rendering the viewable cell for presentation to a user, thereby displaying document content; and
avoiding rendering the non-viewable cell while it is not viewable;
whereby the method is further characterized in that the method opens the document and displays document content in the editor without first rendering more than one-tenth of the document.

18. The storage medium of claim 17, wherein rendering the viewable cell for presentation to the user is performed as part of rendering a viewable portion of the document, and wherein:
rendering the viewable portion comprises rendering textual content in a foreground layer and rendering rich content in a background layer;
wherein the textual content includes at least one of: natural language text, or source code which is not configured for execution within the document editor; and
wherein the rich content includes at least one of: hypertext markup language, script code which is configured for execution within the document editor, or an interactive graph.

19. The storage medium of claim 17, wherein the method renders rich content of a first viewable cell in a sandbox, and the method renders non-rich content of a second viewable cell outside the sandbox for presentation to the user in a textual editor in an integrated development environment.

20. The storage medium of claim 17, wherein the method further comprises utilizing multiple background layers for rendering respective cells of the document, and also utilizing at least one foreground layer for rendering at least one other cell of the document.
